(19) United States
(12) Patent Application Publication
(10) Pub. No.: US 2007/0056946 A1
(43) Pub. Date: Mar. 15, 2007

(54) Warming device for a car seat cover

(76) Inventor: Chien-Chou Chen, Jiali Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,116

(22) Filed: Sep. 14, 2005

(51) Int. Cl. H05B 3/00

(52) U.S. Cl. 219/202; 219/217

(57) ABSTRACT

A warming device for a car seat cover includes a heating layer, and a cord; the heating layer is sandwiched between two layers of a car seat cover, and it is made of electricity-conducting carbon fiber cloth with high resistance; the cord is connected to both the heating layer and a supply of electricity at two ends thereof; electric currents will travel from the supply of electricity to the heating layer through the cord when the warming device is switched on; when electrical energy travels to the heating layer, it will be transformed into heat energy to warm the seat cover because of the high resistance of carbon fiber cloth, which the heating layer is made of.

### BACKGROUND OF THE INVENTION

1. Field of the Invention

The present invention relates to a warming device for a car seat cover, more particularly one, which includes a heating layer sandwiched between two layers of a car seat cover and electrically connected to a supply of electricity for warming the seat cover directly.

2. Brief Description of the Prior Art

Common car seat covers include a seat portion, and a back portion, which are respectively positioned around a seat part, and a back of a car seat for preventing the car seat from getting dirtied.

People demand higher and higher life quality with the advance of technology. And, the industry have been working to develop car seat covers that have other practical functions besides preventing car seats from getting dirtied.

### SUMMARY OF THE INVENTION

A warming device for a car seat cover includes a heating layer sandwiched between two layers of a car seat cover, and a cord connected to both the heating layer and a supply of electricity at two ends. The heating layer is made of electricity-conducting carbon fiber cloth with high resistance. Electric currents will travel from the supply of electricity to the heating layer through the cord when the warming device is switched on. And, electrical energy will be transformed into heat energy because of the high resistance of carbon fiber cloth, which the heating layer is made of. Consequently, the car seat cover becomes warm.

### BRIEF DESCRIPTION OF THE DRAWINGS

The present invention will be better understood by referring to the accompanying drawings, wherein:

FIG. 1 is an exploded perspective view of the warming device for a car seat cover in the present invention,

FIG. 2 is a partial exploded perspective view of the warming device in the present invention,

FIG. 3 is a sectional view of the seat in the present invention, and

FIG. 4 is a partial view of the warming device in use.

### DETAILED DESCRIPTION OF THE PREFERRED EMBODIMENTS

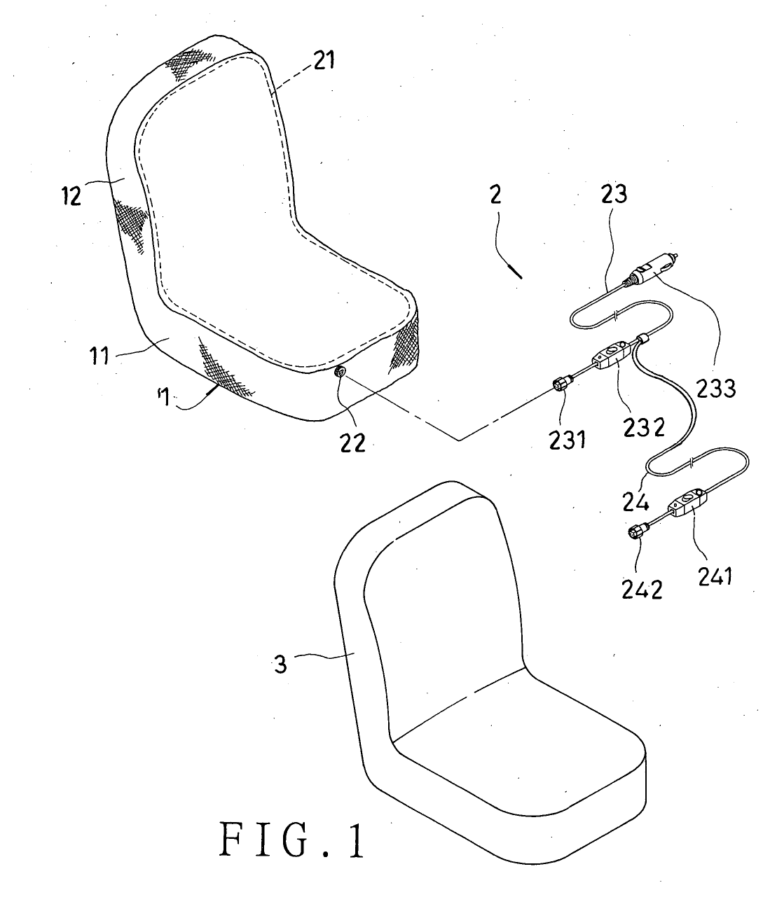

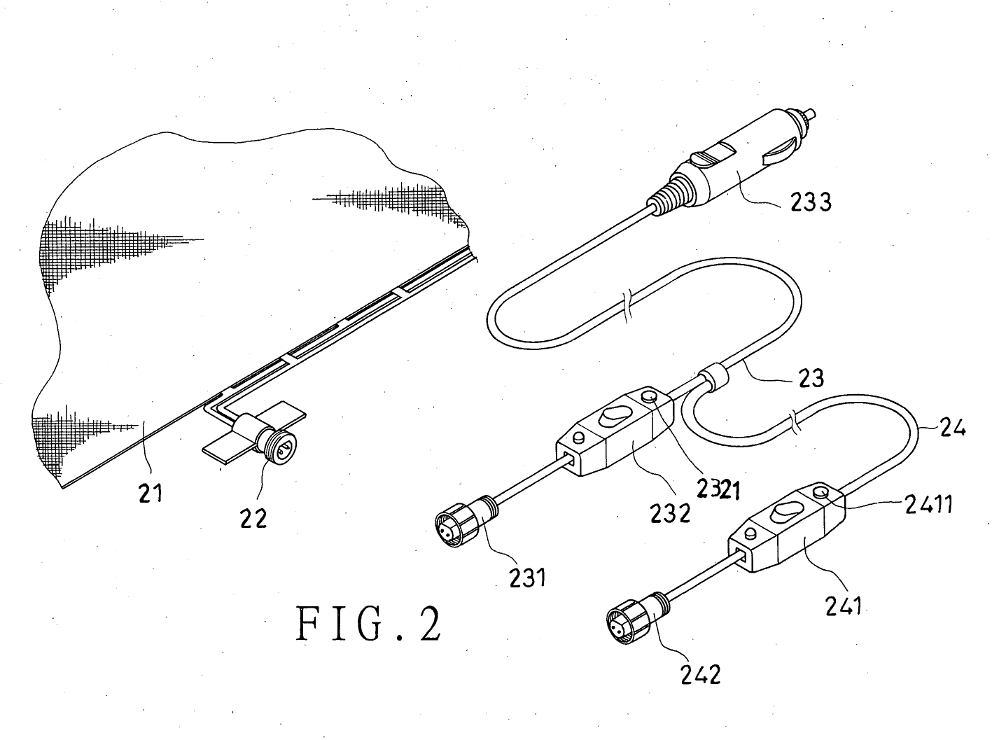

Referring to FIGS. 1 and 2, a preferred embodiment of a warming device 2 for a car seat cover includes a heating layer 21, a connection unit, which includes an electricity-conducting connection 22, cords 23, 24, a plug 233, connections 231, 242, and switches 232, 241.

The heating layer 21 is made of electricity-conducting carbon fiber cloth with high resistance. A lower part of the heating layer 21 is sandwiched between two layers of a seat part 11 of a car seat cover 1 while an upper part of the heating layer 21 is sandwiched between two layers of a back part 12 of the car seat cover 1.

The electricity-conducting connection 22 is connected to the heating layer 21, and projected outside the car seat cover 1. The plug 233 is provided for connection to a car cigarette lighter, and it is connected to one end of the cord 23. The connection 231 is connected to the other end of the cord 23. The switch 232 is connected to intermediate portions of the cord 23, and it is equipped with a timing device 2321. The cord 24 is connected to the cord 23 at one end, and connected to the connection 242 at the other end. The switch 241 is equipped with a timing device 2411, and connected to intermediate portions of the cord 24. The connection 242 is provided for connection to a second electricity-conducting connection, which is connected to a second heating layer and projected outside a second car seat cover (not shown), in which the second heating layer is sandwiched.

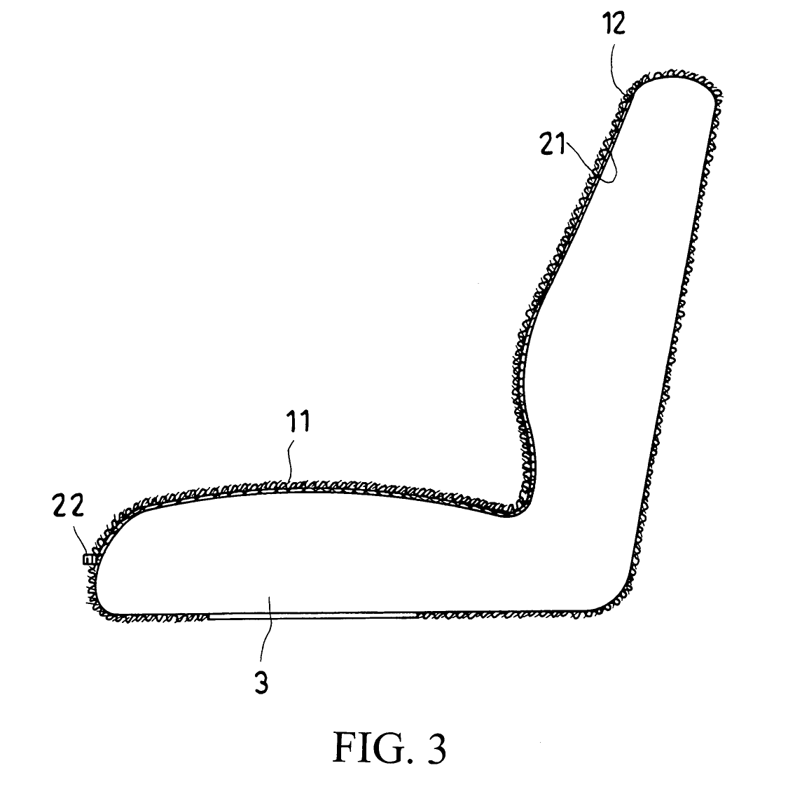

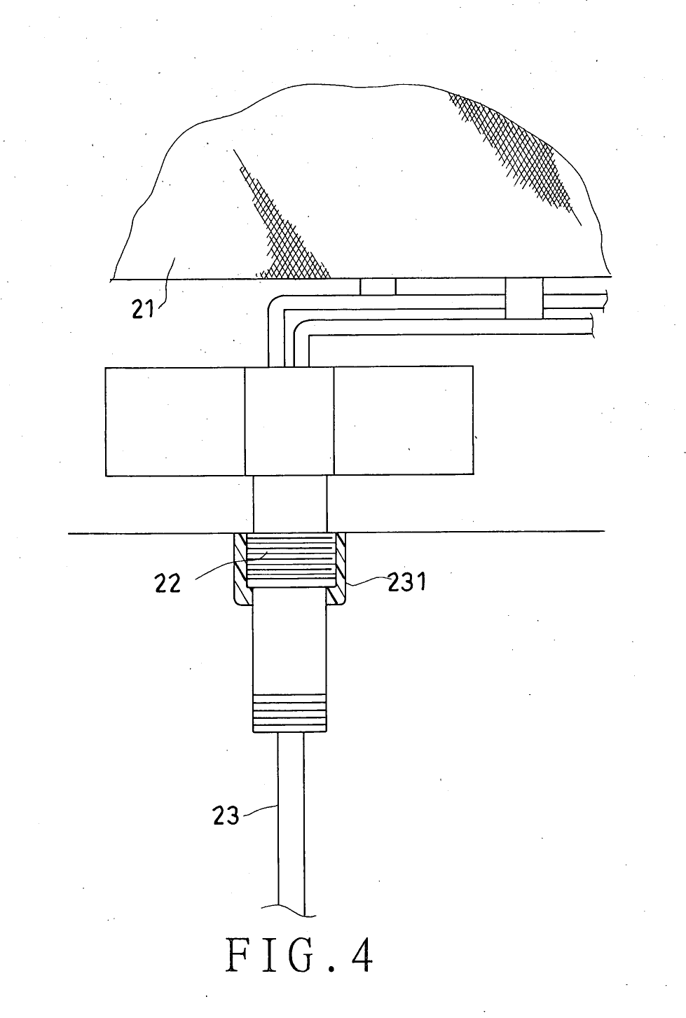

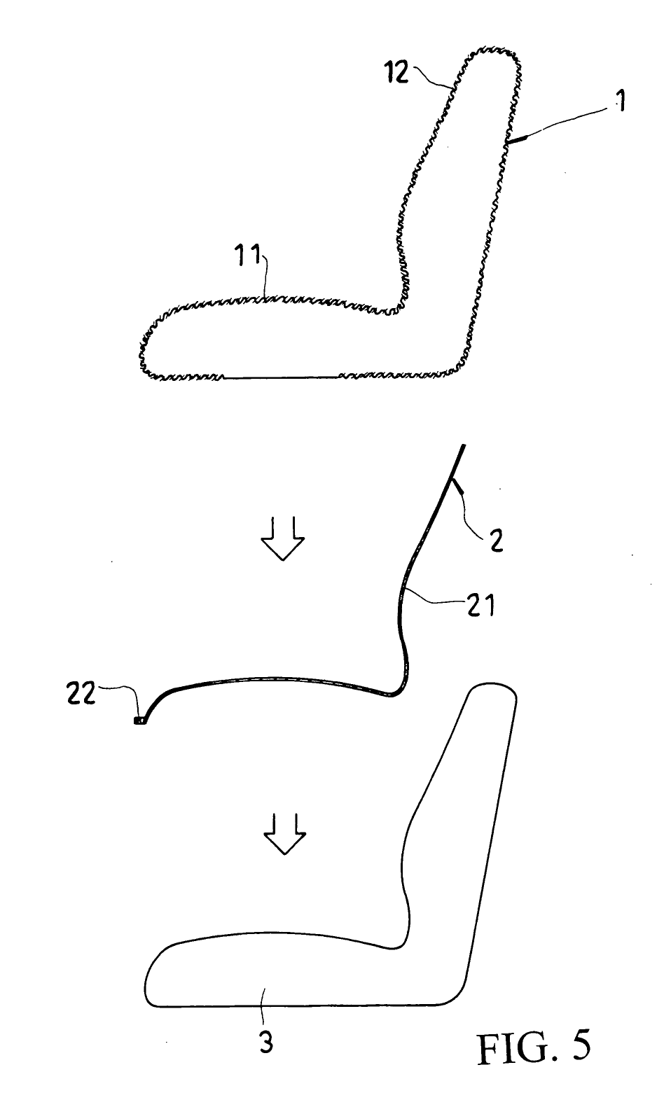

To use the warming device, referring to FIGS. 2 to 4, the plug 233 is connected to a car cigarette lighter (not shown), and the connection 231 is connected to the electricity-conducting connection 22 after the car seat cover 1 is positioned over a car seat 3. Thus, electric currents will travel from the supply of electricity to the heating layer 21 through the plug 233, the cord 23, and the connection 231. And, electrical energy will be transformed into heat energy because of the high resistance of carbon fiber cloth, which the heating layer 21 is made of, making the car seat cover 1 warmer. In addition, the connection 242 is connected to the second electricity-conducting connection, which is connected to the second heating layer; thus, the second car seat cover is also warmed by the present warming device.

Furthermore, besides using the switches 232 and 241 to switch on or off the warming device 2, the user is allowed to set the timing devices 2321 and 2411 such that the warming device 2 will be automatically switched on and off at predetermined time, preventing waste of energy resulting from the user forgetting to switch off the warming device 2 before he leaves the car.

From the above description, it can be easily seen that the warming device of the present invention can effectively make a car seat warmer, preventing discomfort and illness caused by low temperature of the seat of a car.

1. A warming device for a car seat cover, comprising: a heating layer with high resistance sandwiched between a car seat cover and a car seat; and
a cord for connecting the heating layer to a supply of electricity, whereby heat is dissipated substantially uniformly throughout said heating layer.

2. The warming device for a car seat cover as claimed in claim 1, wherein the cord is connected to the heating layer at one end, and a plug at other end, which plug is provided for connection to a car cigarette lighter.

3. The warming device for a car seat cover as claimed in claim 1, wherein an electricity-conducting connection is connected to the heating layer, and projected outside the car seat cover while the cord has a connection at one end for connection to the electricity-conducting connection of the heating layer.

4. The warming device for a car seat cover as claimed in claim 1, wherein the heating layer is made of electricity-conducting carbon fiber cloth with high resistance.

5. The warming device for a car seat cover as claimed in claim 1, wherein the cord has a switch connected thereto.

6. The warming device for a car seat cover as claimed in claim 5, wherein the switch is equipped with a timing device.

7. The warming device for a car seat cover as claimed in claim 1, wherein a second cord is connected to the cord at one end thereof, and connected to a second connection at other end, which second connection is provided for connection to a second electricity-conducting connection connected to a second heating layer and projected outside a second car seat cover, in which the second heating layer is sandwiched.

8. The warming device for a car seat cover as claimed in claim 7, wherein the second cord has a switch connected thereto.

9. The warming device for a car seat cover as claimed in claim 8, wherein the switch connected to the second cord is equipped with a timing device.
